(19) United States
(12) Patent Application Publication
(10) Pub. No.: US 2025/0208837 A1
(43) Pub. Date: Jun. 26, 2025

(54) USING NATURAL LANGUAGE TO PERFORM CONTEXT-AWARE CODE GENERATION

(71) Applicant: AUGMENT COMPUTING, INC., PALO ALTO, CA (US)

(72) Inventors: COLIN FLAHERTY, NEW YORK, NY (US); IGOR OSTROVSKY, MOUNTAIN VIEW, CA (US); GUY GUR-ARI KRAKOVER, PALO ALTO, CA (US); XUANYI DONG, MOUNTAIN VIEW, CA (US); YURII VOLKOV, SAN FRANCISCO, CA (US)

(21) Appl. No.: 18/638,027

(22) Filed: Apr. 17, 2024

Related U.S. Application Data
(60) Provisional application No. 63/587,251, filed on Oct. 2, 2023.

(51) Int. Cl. G06F 8/35; G06F 8/33

(52) U.S. Cl. CPC G06F 8/35; G06F 8/33

(57) ABSTRACT

Asing natural language to perform context-aware code generation, including: receiving a selection of code and a natural language task describing a modification to the selection of code; and generating, by a code generation model and based on information retrieved from a knowledge base provided as input to the code generation model, suggested code reflecting the modification to the selection of code.

### CROSS REFERENCE TO RELATED APPLICATION

This is a non-provisional application for patent entitled to a filing date and claiming the benefit of earlier-filed U.S. Provisional Patent Application No. 63/587,251, filed Oct. 2, 2023, herein incorporated by reference in its entirety.

### BRIEF DESCRIPTION OF DRAWINGS

FIG. 1 a block diagram of an example system for using natural language to perform context-aware code generation in accordance with some embodiments of the present disclosure.

FIG. 2 sets forth a block diagram of an example computing environment configured for using natural language to perform context-aware code generation in accordance with some embodiments of the present disclosure.

FIG. 3 sets forth a flow chart illustrating an example method of enterprise specific code generation using generative AI in accordance with some embodiments of the present disclosure.

FIG. 4 sets forth a flow chart illustrating an example method of using natural language to perform context-aware code generation in accordance with some embodiments of the present disclosure.

FIG. 5 sets forth a flow chart illustrating an additional example method of using natural language to perform context-aware code generation in accordance with some embodiments of the present disclosure.

FIG. 6 sets forth a flow chart illustrating an additional example method of using natural language to perform context-aware code generation in accordance with some embodiments of the present disclosure.

FIG. 7 sets forth a flow chart illustrating an additional example method of using natural language to perform context-aware code generation in accordance with some embodiments of the present disclosure.

### DETAILED DESCRIPTION

The present disclosure relates to methods, products, apparatuses, and services for using natural language to perform context-aware code generation. Generative AI is a category of artificial intelligence that focuses on creating and generating new data, content, or information. Systems, software, and services that leverage generative AI (hereafter referred to as ‘generative AI systems’) may be able to produce outputs that resemble human-generated content, such as text, audio, and more, often enabled through the usage of deep learning techniques and neural networks. In one particular embodiment, generative AI systems may be able to produce computer program code (also referred to hereafter simply as ‘code’) in a variety of programming languages, as pseudo-code, or in some other way.

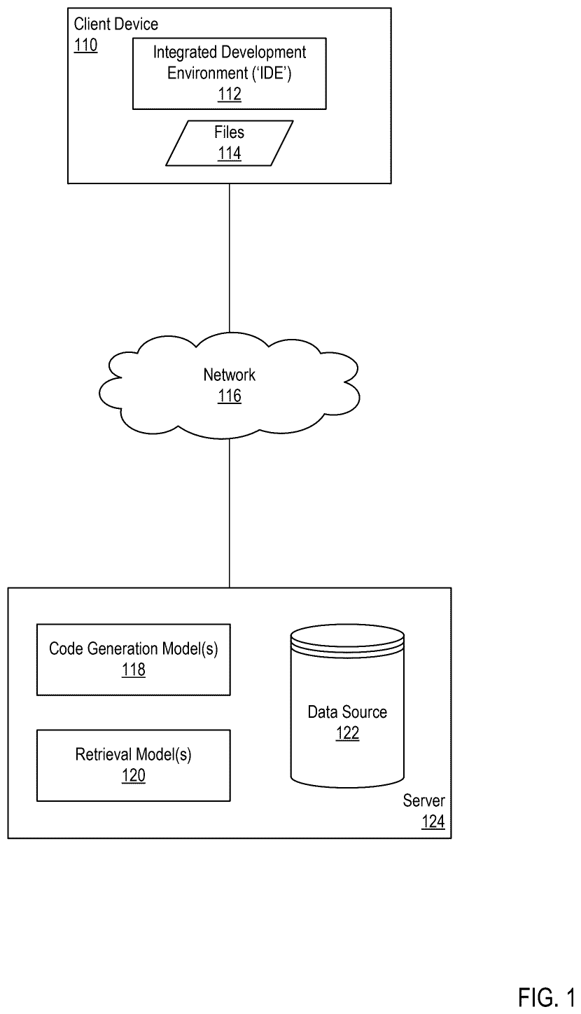

FIG. 1 is a block diagram of an example system in which one or more models are leveraged for using natural language to perform context-aware code generation. FIG. 1 includes a client device 110 and a server 124 that are connected via a network 116. The network 116 depicted in FIG. 1 may be embodied, for example, as a system (including a collection of networking devices, data communications links, and so on) that enables the exchange of digital information between multiple devices (e.g., endpoints), where in this embodiment those devices or endpoints include the client device 110 and the server 124. The network 116 may leverage physical or wireless medium to carry data between nodes using one or more data communications protocols. Such data communications protocols may include the rules and conventions that govern how data is formatted, transmitted, and received within the network 116. Such protocols can include, for example, TCP/IP, HTTP, SMTP, cellular protocols, and many others. Such a network 116 may be embodied as, for example, a Local Area Network (‘LAN’) that covers a small geographical area, a Wide Area Network (‘WAN’) that spans larger regions, a Virtual Private Network (‘VPN’) that uses encryption to create secure and private communication channels, the internet, or in some other way.

The client device 110 depicted in FIG. 1 may be embodied, for example, as a computer, smartphone, tablet, or other computing device that accesses and utilizes services provided by the server 124. The client device 110 will be described in greater detail herein, but the client device 110 may also include one or more applications or user interfaces that allows users of the client device 110 to interact with the server 124, one or more modules of software and hardware that enable the client device 110 to communicate with the server 124 by sending messages, packets, and the like to the server 124, various hardware components such as computer processors, memory, storage, networking interfaces, and much more. The client device 110 may also include one or more displays (e.g., a connected monitor, a touchscreen) and one or more user input devices (e.g., a keyboard, a mouse, a touchscreen) that enable users of the client device 110 to interact with the client device 110.

In the example depicted in FIG. 1, the client device 110 includes an integrated development environment (‘IDE’) 112. The IDE 112 may be embodied, for example, as a software application that provides an integrated set of tools and features to streamline the software development process. IDEs 112 may be used by developers to write, test, and debug code more efficiently, and may include features to support software development tasks such as coding, debugging, and project management. Examples of IDEs 112 that may be supported by the client device 110 can include, for example, Visual Studio, IntelliJ IDEA, Eclipse, NetBeans, PyCharm, and many others. The particular IDE 112 that is leveraged may depend on the programming language and platform being used.

In the example depicted in FIG. 1, the IDE 112 can include (amongst other modules and features) a code editor, which may be embodied as an interface that is used by a software developer to write, edit, and view source code. The editor may include features like syntax highlighting, code formatting to enhance code readability, and code completion features that may be augmented by interactions with the server 124 as described in greater detail herein.

In the example depicted in FIG. 1, the IDE 112 (or some other tool) may be used to access and/or manage one or more files 114. The one or more files 114 can include, for example, source code files that contain the instructions and logic for the software being developed (written in Java, Python, C++, or some other programming language), header files or other library files, configuration files which may specify settings and parameters for the application being developed, template files, script files, documentation files, configuration files for the IDE 112, and many others.

The server 124 depicted in FIG. 1 may be embodied, for example, as one or more computers (although in other embodiments the server 124 may be embodied as one or more hosted application(s)) that provides services, resources, or data to one or more client devices 110 over a network 116. The server 124 may include dedicated hardware systems designed to handle heavy workloads and ensure reliability, although in other embodiments the server 124 may be implemented through software on standard computers. Specialized server operating systems and software may even be used to optimize performance, security, or for some other purpose.

The server 124 depicted in FIG. 1 includes one or more code generation model(s) 118. The code generation model(s) 118 depicted in FIG. 1 may be embodied, for example, as one or more machine learning models designed to generate executable source code for various programming tasks. The code generation model(s) 118 may utilize natural language processing and machine learning techniques to understand and generate code in programming languages like Python, JavaScript, Java, C-based languages, and others. The code generation model(s) 118 may leverage deep learning architectures, such as recurrent neural networks (RNNs), transformers, or hybrid models that combine convolutional and recurrent layers.

In the examples depicted in FIG. 1, the code generation model(s) 118 may be configured to generate enterprise specific code. In other embodiments, the generated code may not be ‘enterprise’ specific but may be specific to some other group of users, some other entity that has associated computer code, or any other entity. In some embodiments, the code generation model(s) 118 generate enterprise (or entity) specific code, for example, in the sense that the code generation model(s) 118 are trained on code for a particular enterprise (e.g., a particular business organization, a particular business unit within a particular business organization) or entity, in the sense that code generation model(s) 118 leverage a knowledge base that is specific to some particular enterprise or entity (e.g., the enterprise's code base), or in some other way. As such, the code generation model(s) 118 depicted here may produce output that is tailored for a specific enterprise or entity as it adheres to their standards, leverages their code base, is written in their same style, and so on.

The code generation model(s) 118 depicted in FIG. 1 may be configured to consider the context in which the code is generated, as the code generation model(s) 118 can take into account any surrounding code or variables that may influence the code generation process. The code generation model(s) 118 may be used for code completion tasks where the code generation model(s) 118 are used to assist developers by providing code completion suggestions as the developer writes code. That is, the code generation model(s) 118 may (via the IDE 112) be provided with information describing where a user's cursor is positioned within a code editor, what code precedes the cursor, what code follows the cursor, and so on, as inputs to code completion process.

In the example depicted in FIG. 1, the server 124 can also include one or more retrieval model(s) 120. The retrieval model(s) 120 depicted in FIG. 1 may be embodied, for example, as machine learning models used for generating responses or recommendations based on retrieving and selecting relevant pre-existing content from a database or knowledge base (depicted herein as data source 122). The retrieval model(s) 120 may therefore leverage existing data or content to provide responses that are contextually appropriate and accurate. Such retrieval model(s) 120 may therefore rely on a database or knowledge base that contains a pre-existing data that serves as a source of information for generating responses. In FIG. 1, the retrieval model(s) 120 rely on information in the depicted data source 122, where the data source 122 can include, for example, a code repository associated with a particular enterprise or entity, documentation associated with the code base, and other information that is relevant to code that has been developed by the particular enterprise or entity.

In the example depicted in FIG. 1, the retrieval model(s) 120 may leverage various techniques such as, for example, feature extraction to identify meaningful features from content in the enterprise's code repository and code in the code editor of the IDE 112, similarity scoring or similar techniques to measure similarity between code in the code editor of the IDE 112 and the content in the data source 122, content ranking and selection, and so on. Such retrieval model(s) 120 may, in some embodiments, be combined with generative models (e.g., the code generation model(s) 120) to create hybrid models that leverages the strengths of both retrieval and generative models to produce more contextually relevant code completion recommendations.

In some embodiments, the retrieval model(s) 120 may be configured to generate precomputed latent representations of stored code (e.g., the code in a particular code base). The latent representation may be embodied, for example, as a floating-point value that captures relevant information about the stored code. Such features may not be directly observed or defined, but instead may be learned by the retrieval model(s) 120 from the raw input data (in this case the stored code). Such latent representations may be made available to the code generation model(s) 118 instead of (or in addition to) the textual representation of the stored code. In such a way, the latent representation may be further processed to encode additional context, deeper understanding, and interconnection with other memories. Furthermore, the systems described herein may refine the latent representations asynchronously and offline (i.e., separately from the process of the code generation model(s) 118 generating code).

In some embodiments, the retrieval model(s) 120 can be enhanced using static analysis of code. Such a process may, in some embodiments, involve statically analyzing existing code (i.e., code from a user's code base) to pick out some fill-in-the-middle (‘FIM’) examples. For example, the retrieval model(s) 120 may be trained with examples of what is typically written between a set of parentheses, examples of what is typically written inside a loop, examples of what is typically written to complete a function, and so on.

In some embodiments, the generative AI systems described here may leverage a set of static code analysis heuristics that work well and can be used to create a dataset that is useful for training models used by generative AI systems that can do FIM for computer program code. In these embodiments, models are trained, and training sets are generated to cover sampling at multiple levels of hierarchy (parenthesis, functions, class, etc. . . . ). The training sets are also created with a distribution that is similar to a distribution that would be similar to a user's knowledge base (i.e., their code repository) so that models behave in accordance with the appropriate distribution.

Readers will appreciate that because each client device 110 has its own set of files 114, a software developer using a first client device may have a different set of files than a client software developer using a second client device. For example, the software developer using a first client device may update some function in a particular file, but without actually committing the updated file to a shared codebase (which may involve rounds of review or other version control procedures), the software developer using a second client device may not have access to the updated function in the particular file. As such, it is not abnormal for users of different client devices to have different versions of a shared codebase.

Readers will further appreciate that because each client device 110 can upload its local files to the server 124, the server 124 may generate different code completion recommendations for a user on a first client device 110 that has a first version of a particular file 114 than it would generate for a user on a second client device 110 that has a second version of a particular files 114, given that the different versions of the particular file 114 could result in different input tokens being sent to the code generation model(s) 118 and/or the retrieval model(s) 120. Readers will appreciate that although some files 114 may be distinct between a first client device and a second client device, some other files 114 may be identical (especially for two developers that are working on the same codebase). As such, and to avoid costly duplication, files (or portions thereof) may be deduplicated so that files (or portions thereof) that are common across multiple client devices 110 are only stored once by the server 124.

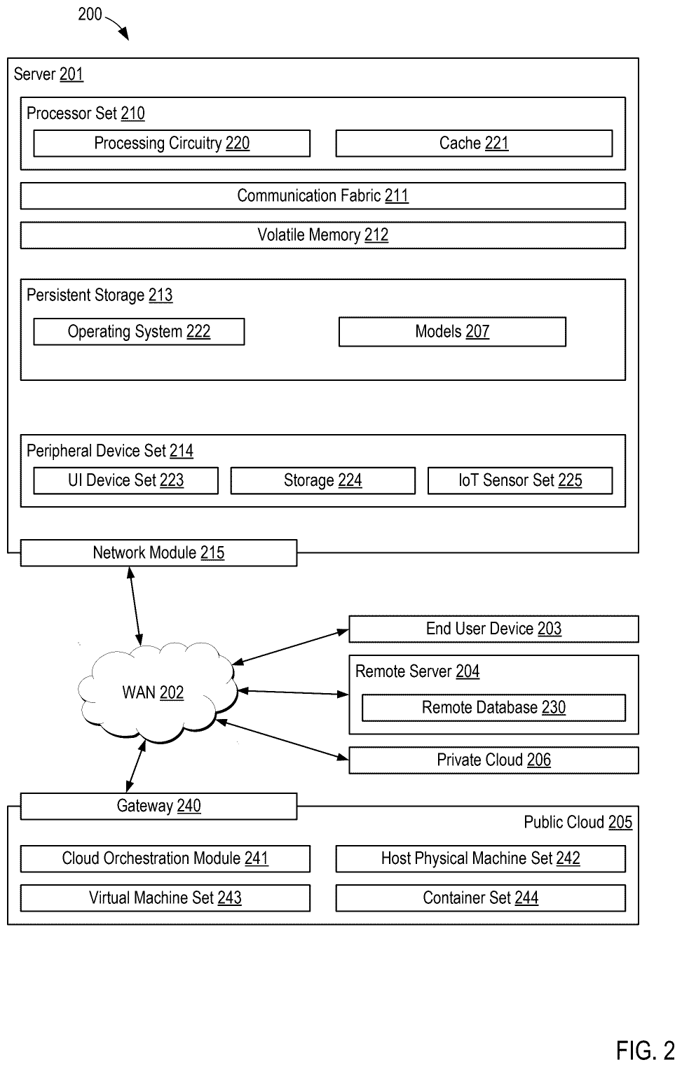

For further explanation, FIG. 2 sets forth a block diagram of an example computing environment 200 configured for using natural language to perform context-aware code generation in accordance with some embodiments of the present disclosure. Computing environment 200 contains an example of an environment for the execution of at least some of the computer code involved in performing the inventive methods, such as various models 207 that may correspond to the models described in FIG. 1 and elsewhere in the present disclosure. In addition to models 207, computing environment 200 includes, for example, computer 201, wide area network (‘WAN’) 202, end user device (‘EUD’) 203 that may be similar to the client device of FIG. 1, remote server 204, public cloud 205, and private cloud 206. In this example embodiment, computer 201 includes processor set 210 (including processing circuitry 220 and cache 221), communication fabric 211, volatile memory 212, persistent storage 213 (including operating system 222 and models 207), peripheral device set 214 (including user interface (‘UI’) device set 223, storage 224, and Internet of Things (‘IoT’) sensor set 225), and network module 215. Remote server 204 includes remote database 230. Public cloud 205 includes gateway 240, cloud orchestration module 241, host physical machine set 242, virtual machine set 243, and container set 244.

Computer 201 may take the form of a desktop computer, laptop computer, tablet computer, smart phone, mainframe computer, quantum computer or any other form of computer or mobile device now known or to be developed in the future that is capable of running a program, accessing a network or querying a database, such as remote database 230. As is well understood in the art of computer technology, and depending upon the technology, performance of a computer-implemented method may be distributed among multiple computers and/or between multiple locations. On the other hand, in this presentation of computing environment 200, detailed discussion is focused on a single computer, specifically computer 201, to keep the presentation as simple as possible. Computer 201 may be located in a cloud, even though it is not shown in a cloud in FIG. 2. On the other hand, computer 201 is not required to be in a cloud except to any extent as may be affirmatively indicated.

Processor set 210 includes one, or more, computer processors of any type now known or to be developed in the future. Processing circuitry 220 may be distributed over multiple packages, for example, multiple, coordinated integrated circuit chips. Processing circuitry 220 may implement multiple processor threads and/or multiple processor cores. Cache 221 is memory that is located in the processor chip package(s) and is typically used for data or code that should be available for rapid access by the threads or cores running on processor set 210. Cache memories are typically organized into multiple levels depending upon relative proximity to the processing circuitry. Alternatively, some, or all, of the cache for the processor set may be located “off chip.” In some computing environments, processor set 210 may be designed for working with qubits and performing quantum computing.

Computer readable program instructions are typically loaded onto computer 201 to cause a series of operational steps to be performed by processor set 210 of computer 201 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 221 and the other storage media discussed below. The program instructions, and associated data, are accessed by processor set 210 to control and direct performance of the inventive methods. In computing environment 200, at least some of the instructions for performing the inventive methods may be stored in models 207 in persistent storage 213.

Communication fabric 211 is the signal conduction path that allows the various components of computer 201 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 212 is any type of volatile memory now known or to be developed in the future. Examples include dynamic type random access memory (RAM) or static type RAM. Typically, volatile memory 212 is characterized by random access, but this is not required unless affirmatively indicated. In computer 201, the volatile memory 212 is located in a single package and is internal to computer 201, but, alternatively or additionally, the volatile memory may be distributed over multiple packages and/or located externally with respect to computer 201.

Persistent storage 213 is any form of non-volatile storage for computers that is now known or to be developed in the future. The non-volatility of this storage means that the stored data is maintained regardless of whether power is being supplied to computer 201 and/or directly to persistent storage 213. Persistent storage 213 may be a read only memory (ROM), but typically at least a portion of the persistent storage allows writing of data, deletion of data and re-writing of data. Some familiar forms of persistent storage include magnetic disks and solid-state storage devices. Operating system 222 may take several forms, such as various known proprietary operating systems or open-source Portable Operating System Interface-type operating systems that employ a kernel. The models 207 typically includes at least some of the computer code involved in performing the inventive methods.

Peripheral device set 214 includes the set of peripheral devices of computer 201. Data communication connections between the peripheral devices and the other components of computer 201 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 223 may include components such as a display screen, speaker, microphone, wearable devices (such as goggles and smart watches), keyboard, mouse, printer, touchpad, game controllers, and haptic devices. Storage 224 is external storage, such as an external hard drive, or insertable storage, such as an SD card. Storage 224 may be persistent and/or volatile. In some embodiments, storage 224 may take the form of a quantum computing storage device for storing data in the form of qubits. In embodiments where computer 201 is required to have a large amount of storage (for example, where computer 201 locally stores and manages a large database) then this storage may be provided by peripheral storage devices designed for storing very large amounts of data, such as a storage area network (‘SAN’) that is shared by multiple, geographically distributed computers. IoT sensor set 225 is made up of sensors that can be used in Internet of Things applications. For example, one sensor may be a thermometer and another sensor may be a motion detector.

Network module 215 is the collection of computer software, hardware, and firmware that allows computer 201 to communicate with other computers through WAN 202. Network module 215 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 215 are performed on the same physical hardware device. In other embodiments (for example, embodiments that utilize software-defined networking (SDN)), the control functions and the forwarding functions of network module 215 are performed on physically separate devices, such that the control functions manage several different network hardware devices. Computer readable program instructions for performing the inventive methods can typically be downloaded to computer 201 from an external computer or external storage device through a network adapter card or network interface included in network module 215. Network module 215 may be configured to communicate with other systems or devices.

WAN 202 is any wide area network (for example, the internet) capable of communicating computer data over non-local distances by any technology for communicating computer data, now known or to be developed in the future. In some embodiments, the WAN 202 may be replaced and/or supplemented by local area networks (‘LANs’) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End User Device (‘EUD’) 203 is any computer system that is used and controlled by an end user (for example, a customer of an enterprise that operates computer 201), and may take any of the forms discussed above in connection with computer 201. In some embodiments, the EUD 203 may perform all of the functions of the client device of FIG. 1 and may include the IDE and other components described with reference to FIG. 1 and elsewhere in the present disclosure. EUD 203 typically receives helpful and useful data from the operations of computer 201. For example, in a hypothetical case where computer 201 is designed to provide a recommendation to an end user, this recommendation would typically be communicated from network module 215 of computer 201 through WAN 202 to EUD 203. In this way, EUD 203 can display, or otherwise present, the recommendation to an end user. In some embodiments, EUD 203 may be a client device, such as thin client, heavy client, mainframe computer, desktop computer and so on. Remote server 204 is any computer system that serves at least some data and/or

functionality to computer 201. Remote server 204 may be controlled and used by the same entity that operates computer 201. Remote server 204 represents the machine(s) that collect and store helpful and useful data for use by other computers, such as computer 201. For example, in a hypothetical case where computer 201 is designed and programmed to provide a recommendation based on historical data, then this historical data may be provided to computer 201 from remote database 230 of remote server 204.

Public cloud 205 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 205 is performed by the computer hardware and/or software of cloud orchestration module 241. The computing resources provided by public cloud 205 are typically implemented by virtual computing environments that run on various computers making up the computers of host physical machine set 242, which is the universe of physical computers in and/or available to public cloud 205. The virtual computing environments (‘VCEs’) typically take the form of virtual machines from virtual machine set 243 and/or containers from container set 244. It is understood that these VCEs may be stored as images and may be transferred among and between the various physical machine hosts, either as images or after instantiation of the VCE. Cloud orchestration module 241 manages the transfer and storage of images, deploys new instantiations of VCEs and manages active instantiations of VCE deployments. Gateway 240 is the collection of computer software, hardware, and firmware that allows public cloud 205 to communicate through WAN 202.

Some further explanation of virtualized computing environments (‘VCEs’) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 206 is similar to public cloud 205, except that the computing resources are only available for use by a single enterprise. While private cloud 206 is depicted as being in communication with WAN 202, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 205 and private cloud 206 are both part of a larger hybrid cloud.

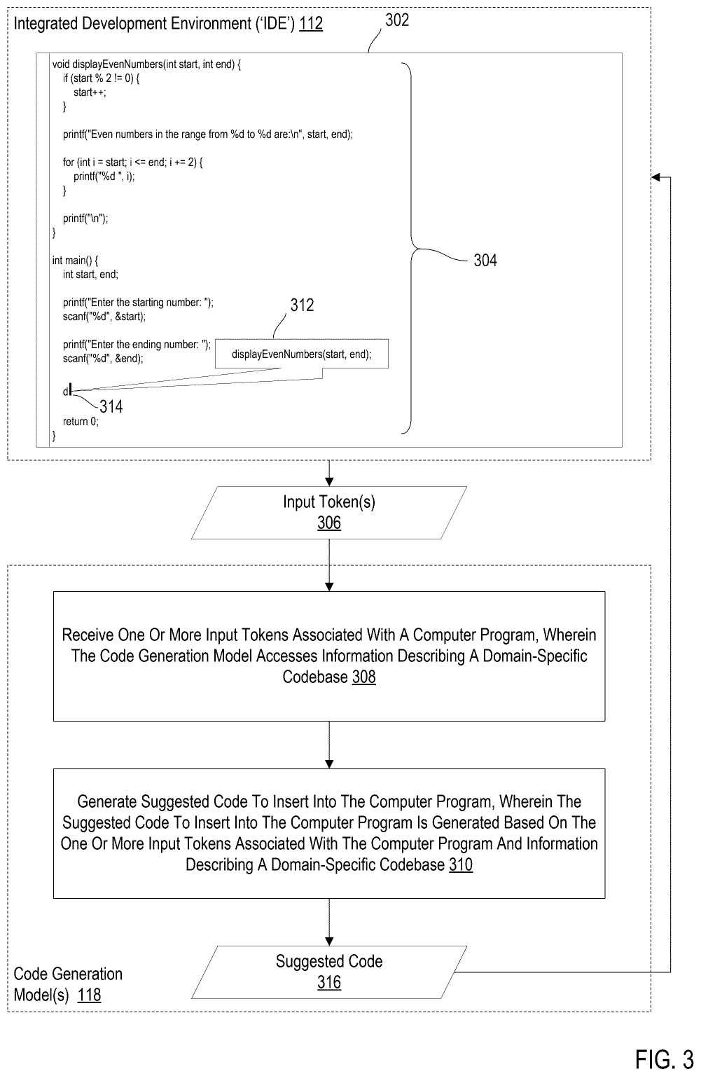

For further explanation, FIG. 3 sets forth a flow chart illustrating an example method of enterprise specific code generation using generative AI in accordance with some embodiments of the present disclosure. The example method depicted in FIG. 3 includes one or more code generation model(s) 118 and an IDE 112 as described elsewhere in the present disclosure.

In the example depicted in FIG. 3, the IDE 112 includes a code editor 302, where a computer program 304 that displays even numbers between two input parameters. In this example, the computer program 304 is intended to be depicted as being in draft, with a software developer drafting code that is included in the computer program 304. More specifically, the software developer's cursor 314 is depicted near the bottom of the computer program 304, as the developer is writing a line of code that begins with the letter “d” followed by the cursor 314. In this example, the code editor 302 is depicted as displaying a recommended code completion 312 that is generated as will be described in greater detail below. The recommended code completion 312 includes a function call to the displayEventNumbers function that is defined in the code editor 302. Readers will appreciate that this example is purposefully intended to be quite simple for ease of explanation, but in other embodiments the recommended code completion 312 may be far more complex, may be presented in other ways, and so on. In fact, although this embodiment illustrates an example in which recommended code completions 312 are presented to a software developer via an IDE 112, in other embodiments the systems, methods, products, modules, or components described herein may be used to automatically generate entire software applications, functions, and so on.

The example method depicted in FIG. 3 includes receiving 308, by a code generation model 118, one or more input tokens 306 associated with a computer program 304. The one or more input tokens 306 may be discrete units of information (e.g., text, some representation of text such as a hash of the text) that are used to as input to the code generation model(s) 118. For example, a first token may include some representation of the text that precedes the location of the cursor 314 in the computer program 304, a second token may include some representation of text that follows the location of the cursor 314, and so on. In fact, many tokens may be generated that represent different portions of the text that precedes the location of the cursor 314, different portions of the text that follows the location of the cursor 314, representations of portions of documentation associated with the computer program 304, representations of libraries that are utilized by the computer program 304, representations infrastructure-as-code (‘IaC’) templates for the environment that executes the computer program 304, and so on. In such a way, the tokens can essentially represent the state of the computer program 304 that is being developed.

Readers will appreciate that the input tokens 306 can essentially guide the behavior of the code generation model(s) 118 and can be important inputs that drive the output of the code generation model(s) 118. Each input token 306 may be part of a sequence of input tokens 306 that collectively form the input to the code generation model(s) 118. Readers will appreciate that input tokens 306 can be of differing types that may determine how the code generation model(s) 118 interprets and processes each particular input token 306. Readers will further appreciate that the position of each input token 306 in the input sequence signifies the order or context in which the input token 306 appears, as the preceding and following input tokens 306 in the input sequence provides context for a particular input token 306. In such a way, the context helps the code generation model(s) 118 understand the relationships and dependencies between various input tokens 306, thereby helping the code generation model(s) 118 generate accurate and contextually relevant suggested code 316 that can ultimately be presented as a recommended code completion 312 or leveraged in some other way. The input tokens 306 may be generated by the IDE 112 or some other module performing a variety of steps, including preprocessing steps to clean and structure the code data. This process may involve performing tokenization steps, separating code into individual tokens (e.g., keywords, operators, identifiers), removing irrelevant or sensitive information, and performing other preprocessing steps to generate the input tokens 306.

In the example method depicted in FIG. 3, the one or more input tokens 306 associated with the computer program 304 may be generated by the IDE 112, by a plug-in or extension for the IDE 112, by some other module that is accessible by the IDE 112, or by some other intervening module between the IDE 112 and the code generation model(s) 118. The one or more input tokens 306 associated with the computer program 304 may be received 308 by the code generation model(s) 118, for example, via one or more messages that are received by the code generation model(s) 118, via one or more queues or other data structure that the IDE 112 inserts input tokens 306 into and that the code generation model(s) 118 retrieves input tokens 306 from, via the IDE 112 directly writing (e.g., via an RDMA or RDMA-like operation) the input tokens 306 into memory on server (124 in FIG. 1) that supports the execution of the code generation model(s) 118, or in some other way.

In the example method depicted in FIG. 3, the code generation model 118 may access information describing a domain-specific codebase. The domain-specific codebase may be embodied, for example, as the codebase for a particular business enterprise, as the codebase for a particular business unit within a business enterprise, as the codebase for some collection of software developers, as the codebase for some other entity, and so on. The information describing a domain-specific codebase can also include non-code information such as, for example, documentation associated with a code base, commit histories for code in the code base, information describing an environment some software in the code base will be executed, information describing support tickets for code in the code base, information describing bugs in the code base and their resolution, information describing whether some code was generated by a human developer or generative AI, information identifying which particular software developer wrote some code in the code base, performance information gathered during execution of some code in the code base, environmental information (e.g., schemas in a data warehouse that contains data to be used by the code, cloud infrastructure layout, Remote Procedure Call (‘RPC’) endpoint configurations) describing the environment that code will be executed in, infrastructure information (e.g., information about a Kubernetes pods that may be running, information about the cloud infrastructure) describing the environment that code will be executed in, and so on. The information describing a domain-specific codebase may be embodied, for example, as the data source (122 of FIG. 1) depicted in FIG. 1. Such information may be inserted into the generated code, used to drive some query, or otherwise used by one or more of the models.

In some embodiments, the code generation model(s) 118 may access information describing a domain-specific codebase, for example, by receiving information from a knowledge base that includes code in the domain-specific codebase. Such information may be received from a trained retrieval model (such as the trained retrieval model(s) 120 depicted in FIG. 1). In some embodiments, the retrieval model(s) may be distinct from the code generation model(s) 118, the retrieval model(s) may be trained on a different training set than the code generation model(s) 118, and so on. In some embodiments, multiple retrieval models may be trained to do the retrieval. These retrieval models may be used, for example, to look at a piece of code (i.e., code that is being written by a developer), compare it to some other code/search the knowledge base for the most relevant piece of code, and then present that relevant piece of code to the developer or to another model. To train these retrieval models, the models may need to be provided with many examples of code that is related so as to enable the model to identify related code. To generate a signal that relates two pieces of code, some embodiments may examine existing code repositories and look at each change that is made in the code repository and identify situations in which changing a first piece of code was followed by a second piece of code being changed, as this may be indicative of the first piece of code and the second piece of code being related. This may be especially true in some situations such as, for example, when the same user changed each piece of code in a relatively short period of time. In these embodiments, commit histories from a code management system may be examined to identify the activity described above, or other data sources may be examined to identify activity that may be taken as a signal that some pieces of code are related. In other embodiments, other information may be indicative that some pieces of code are related. For example, if two pieces of code are described in the same document (e.g., a design document), this may be an indication that the two pieces of code are related. Readers will appreciate that such signals (and other signals) may be fairly specific to code rather than language generally, so these signals may be more useful when training retrieval models that are part of a generative AI system that generates computer program code.

In some embodiments, the code generation model(s) 118 may access information describing a domain-specific codebase by retrieving, from a database that includes memories generated by examining the domain-specific codebase, one or more memories. In some embodiments one or more models are trained to store a memory corresponding to each of a plurality of tokens in a database. In such embodiments, models trained to store memories are trained from a corpus of words obtained from a specific enterprise (e.g., a domain or an entity), allowing the memories to reflect contextual information about usage of tokens in the specific enterprise. By using enterprise-specific information to generate memories for tokens, the model is able to account for a specific implementation environment and leverage preferences or criteria specific to the specific domain. For example, a code generation model 118 may be configured to leverage memories when generating suggested code 316 to insert into the computer program 304, where the memories account for coding preferences or specific libraries particular to an enterprise, such as an entity or an organization. This allows different enterprises to use a code constructs, functions, words, or other elements in a computer program in different ways or in different contexts, with the memories generated by the trained model accounting for the enterprise specific usage. In such a way, memories allow the code generation model(s) 118 to provide suggested code 316 that are tailored to the enterprise.

The example method depicted in FIG. 3 also includes generating 310, by the code generation model(s) 118, suggested code 316 to insert into the computer program 304. In the example method depicted in FIG. 3, the suggested code 316 to insert into the computer program 304 is generated based on the one or more input tokens 306 associated with the computer program 304 and information describing a domain-specific codebase.

The code generation model(s) 118 may generate 310 suggested code 316 to insert into the computer program 304, for example, by receiving an initial code snippet (or even a natural language description of a code) in the form of input tokens 306 and predicting the next token in the sequence (or intervening token when the input tokens 306 include tokens before and after a cursor or other reference point). In such an example, the code generation model(s) 118 may generate 310 suggested code 316 in the form of tokens that are generated one by one, taking into account the context provided by the preceding tokens. The code generation model(s) 118 may maintain an internal state that keeps track of the context of the code it is generating, where the context can include variables, function declarations, loops, conditionals, and other elements that are used to generate code that follows a logical and semantically correct structure. The code generation model(s) 118 may therefore be designed to understand and replicate the structure, syntax, and semantics of programming languages and computer programs that the code generation model(s) 118 can access, including those computer programs that are part of the domain-specific codebase. Readers will appreciate that the code generation model(s) 118 may generate code up to a specified length, until a specific stop token is reached, or in some other way.

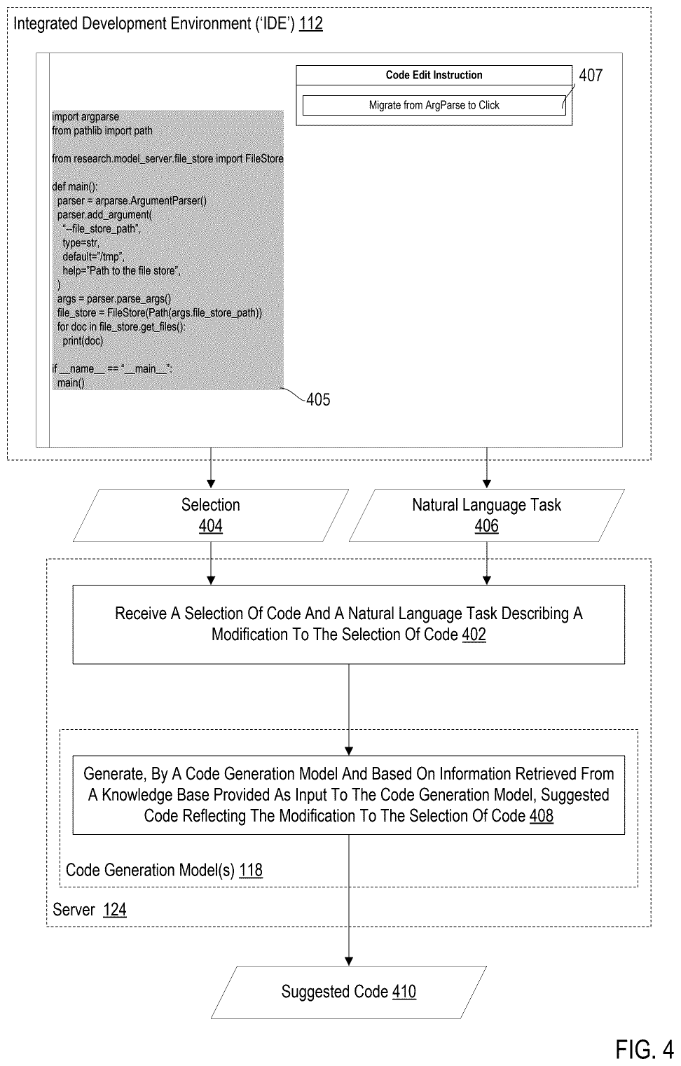

For further explanation, FIG. 4 sets forth a flow chart illustrating an example method of using natural language to perform context-aware code generation in accordance with some embodiments of the present disclosure. The example method depicted in FIG. 4 includes an IDE 112, a server 124, and one or more code generation model(s) 118 as described elsewhere in the present disclosure. In the example depicted in FIG. 4, the IDE 112 includes a portion of code for printing a listing of files in a file store. For example, the IDE 112 may be accessing a file of source code that includes the portion of code. As another example, the IDE 112 may be used to enter some code that will later be saved to a file of source code. Particularly, the portion of code in the IDE 112 uses “argparse,” a Python module for parsing command line arguments. Although the following discussion is presented in the context of code as source code of a computer program, readers will appreciate that the approaches set forth herein may also be applied to other types of code. For example, the approaches set forth herein may be applied to Infrastructure-as-Code (IaC) code or templates, executable scripts, or other code as can be appreciated.

The method of FIG. 4 includes receiving 402 a selection 404 of code and a natural language task 406 describing a modification to the selection 404 of code. The selection 404 of code may be received from the IDE 112. A selection 404 of code is a particularly identified or distinguished amount of code from a file, a computer program, a code base, and the like. Here, the selection 404 of code includes the portion of code described above for printing the listing of files in a file store. The selection 404 of code may be selected using a variety of approaches. For example, in some embodiments, the selection 404 of code may be selected using a user input to the IDE 112 in order to particularly identify the selection 404 of code. In this example, the selection 404 of code is selected by highlighting the selection 404 of code in a code editor of the IDE 112, shown as highlighted code 405. Readers will appreciate that other approaches may also be used to select a selection 404 of code. For example, in some embodiments, particular files of code may be selected via a file browser of the IDE 112.

The natural language task 406 is a description of some modification or transformation to the selection 404 of code that should be reflected in code produced by the code generation model 118. Here, the natural language task 406 is to modify the selection 404 of code from argparse to “click,” a different module for parsing command line arguments. Readers will appreciate that the natural language task 406 may describe a variety of modifications that may be made to some code. For example, in some embodiments, the natural language task 406 may describe a migration of the selection 404 of code, such as a migration from one version of a language to another version of the language, a migration from one language to another language, a migration from use of one library or module to another library or module, and the like. As another example, the natural language task 406 may describe a modification to the selection 404 of code based on some analysis of the selection 404 of code to be performed by the code modification model 118, such as to perform bug fixes based on some bug analysis. As a further example, the natural language task 406 may describe a refactoring of the selection 404 of code whereby the structure of the selection 404 of code may be modified without modifying the original functionality. Readers will appreciate that these example natural language tasks 406 are merely illustrative and that other natural language tasks 406 are also contemplated within the scope of the present disclosures.

The natural language task 406 may also be received from the IDE 112. For example, in some embodiments, the IDE 112 may include a text input field 407 into which natural language tasks 406 may be input by a user. In some embodiments, the text input field 407 may be generated or added to the IDE 112 user interface in response to selecting the selection 404 of code, in response to some other input, or combinations thereof. For example, input of a particular hotkey (e.g., a particular combination of input keys) may cause the text input field 407 to be presented via the IDE 112 interface. As another example, input of a particular hotkey or some other input after a selection 404 of code has been made has been made may cause the text input field 407 to be presented via the IDE 112 interface. As a further example, after a selection 404 of code has been made, another input directed to the selection 404 of code in the IDE 112 interface such as right clicking highlighted code 405 may cause the text input field 407 to be presented or may cause a menu including an element that, when selected, may cause the text input field 407 to be presented. Other approaches may also be used to cause presentation of the text input field 407 in the IDE 112 interface. After selecting the selection 404 of code and inputting a natural language task 406 into the text input field 407, the selection 404 of code and natural language task 406 may be provided from the IDE 112 so as to be received 402.

In some embodiments, rather than an input text field 407, the natural language task 406 may be received via a simulated chat interface of the IDE 112. A simulated chat interface 112 mimics the behavior of a chat interface using a trained model such as a generative AI model that accepts, as input, natural language inputs received from a user via the simulated chat interface. Such a trained model may include a model separate from the code generation model 118. The trained model generates natural language responses and presents them to a user via a message log or message history. Such a message log or message history may present both the natural language inputs from the user and the responses from the trained model. Thus, the simulated chat interface mimics a conversation between a user and another entity whose responses are generated by the trained model.

Accordingly, in some embodiments, the chat interface may serve as a generalized assistant for the IDE 112, code generation functionality performed by the code generation model 118, and the like. The chat interface may accept, from the user, natural language tasks 406 as one of many functions performable using the trained model and the chat interface. In some embodiments, a user may describe, via the chat interface, particular modifications to be performed to a selection 404 of code, particular issues or problems with the selection 404 of code, and the like in order to solicit suggested natural language tasks 406. The trained model may then suggest or propose a natural language task 406 when the user may then accept or confirm via the chat interface.

The method of FIG. 4 also includes generating 408, by a code generation model 118 and based on information retrieved from a knowledge based provided as input to the code generation model 118, suggested code 410 reflecting the modification to the selection 404 of code. In other words, the code generation model 118 generates suggested code 410 by applying the modification described in the natural language task 406 to the selection 404 of code. For example, where the natural language task 406 describes a migration of the selection 404 of code to a new language, the suggested code 410 may include code in the new language that is functionally equivalent to the selection 404 of code. As another example, where the natural language task 406 describes a refactoring of the selection 404 of code, the suggested code 410 may include functionally equivalent refactored code. As a further example, where the natural language task 406 describes removing bugs from the selection 404 of code, the suggested code 410 includes a version of the selection 404 of code with identified bugs removed. In the example of FIG. 4, where the natural language task 406 describes migrating the selection 404 of code from argparse to click, the suggested code 410 will include code that is functionally equivalent to the selection 404 code that uses click instead of argparse.

Generating 408 the suggested code 410 may be performed by the code generation model 118 using similar approaches as are set forth above. For example, the code generation model 118 may be trained to perform various modifications (e.g., to implement various natural language tasks 406). Particular approaches for training the code generation model 118 will be described in further detail below. As is set forth above, the code generation model 118 may generate the suggested code 410 using inputs including the selection 404 of code, the natural language task 406, information from a knowledge base such as the data sources 122 described above (e.g., as retrieved by retrieval models 120), and potentially other information. For example, data sources 122 such as a code base associated with the selection 404 of code, other code bases such as domain-specific code bases, and the like may be accessed to find code that may serve as a relevant input to the code generation model 118 to perform modifications described by a particular natural language task 406.

In some embodiments, after generating 408 the suggested code 410, the suggested code 410 may be inserted into a file accessed by the IDE 112 so as to replace the selection 404 of code. In some embodiments, after generating 408 the suggested code 410, the suggested code 410 may be provided to the IDE 112. In some embodiments, providing the suggested code 410 to the IDE 112 may the IDE 112 to present the suggested code 410 in the code editor of the IDE 112. For example, in some embodiments, providing the suggested code 410 to the IDE 112 may cause the selection 404 of code to be replaced in the code editor of the IDE 112. As another example, in some embodiments, providing the suggested code 410 to the IDE 112 may cause the IDE 112 to present a user interface element such as another frame or window of the code editor that displays the suggested code 410. This may allow a user of the IDE 112 to view the selection 404 of code and the suggested code 410 for comparison. In some embodiments, such a user interface element may allow the user to further modify the suggested code 410. In some embodiments, the user may provide a command or input to the IDE 112 (e.g., an “accept” or “confirm” command) that causes the presented suggested code 410 to replace the presented selection 404 of code. In some embodiments, this may cause the user interface element presenting the suggested code 410 to be removed from the IDE 112 interface.

In some embodiments, depending on the particular natural language task 406, the code generation model 118 may indicate that no suggested code 410 can or should be provided, or may provide the selected code as the selection 404 of code. In other words, depending on the particular natural language task 406, the code generation model 118 may determine that no modifications should be performed on the selection 404 of code. As an example, where the natural language task 406 includes a migration to a particular language, language version, and the like, the code generation model 118 may determine that no modifications should be performed on the selection 404 of code where the selection 404 of code is already encoded in the particular language or version. As another example, where the natural language task 406 includes bug fixing, the code generation model 118 may determine that no modifications should be performed on the selection 404 of code where no bugs are identified. As a further example, where the natural language task 406 includes a refactoring, the code generation model 118 may determine that no modifications should be performed on the selection 404 of code where the code generation model 118 determines that no refactoring is necessary (e.g., where the selection 404 of code conforms to particular standards, conventions, levels of readability or abstraction, and the like). Accordingly, in some embodiments, the code generation model 118 may provide, to the IDE 112, the selection 404 of code as the suggested code 410 or may provide, to the IDE 112, a notification or message indicating that no modifications should be performed on the selection 404 of code.

The approaches set forth above allow for a user to provide natural language descriptions of modifications to be applied to some amount of selected code. The code generation model 118 may then generate suggested code reflecting the natural language description that may then be reviewed by a user and/or inserted into the code so as to replace the selected code. This improves the overall user experience of the IDE 112 and accelerates code modification tasks that may be otherwise laborious, error prone, or complicated when performed manually by a software developer.

Although the approaches set forth describe natural language tasks 406 for modifying a selection 404 of code, in some embodiments, the natural language tasks 406 may describe an analysis to be performed on the code that may or may not result in suggested code 410 generated by the code generation model 118. For example, a natural language tasks 406 may request a review of a selection 404 of code or of code included in a pull request performed or to be performed (e.g., via the IDE 112). The code generation model 118 or another generative AI model may review the code and perform various actions including generating feedback or comments for the code or pull request, accepting or denying the pull request, and the like. In such embodiments, the information accessed from the knowledge base may include previous pull requests and their associated feedback, including pull requests from the same user, pull requests from the same or associated code bases, pull requests for domain-specific code bases, and the like.

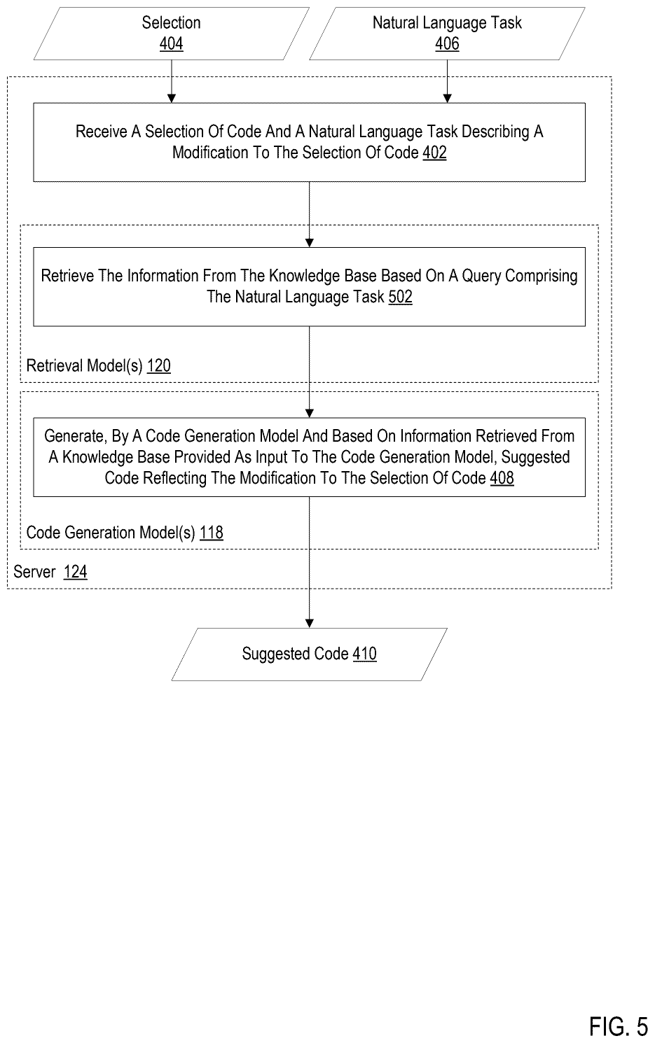

For further explanation, FIG. 5 sets forth a flowchart of another example method of using natural language to perform context-aware code generation in accordance with some embodiments of the present disclosure. The example method depicted in FIG. 5 is similar to the example method depicted in FIG. 4 as the example method depicted in FIG. 5 includes some of the same steps.

The method of FIG. 5 also includes retrieving 502 the information from the knowledge base based on a query comprising the natural language task 406. Retrieving 502 the information from the knowledge base may be performed by a trained retrieval model such as a retrieval model 120 as described above. The knowledge base may include one or more data sources 122 as described above. For example, the knowledge base may include one or more code bases, such as the code base of the selection 404 of code, one or more related and/or domain-specific code bases, associated documentation of such code bases, and the like. Particularly, in addition to various data points that may be used by the retrieval models 120 as set forth above, the query (e.g., to the retrieval models 120) includes the natural language task 406 itself. Thus, the natural language task 406 may serve as a data point in retrieving 502 information from the knowledge base to be provided, as input, to the code generation model(s) 118 to generate 408 the suggested code 410.

As an example, the knowledge base may be accessed to identify related code that may reflect the modification described by the natural language task 406. Continuing with this example, where the natural language task 406 describes a migration to a particular language or particular version of a language, the retrieval models 120 may access related code in that particular language or version of that language. As another example, the knowledge base may be accessed to identify, using comments on pull requests or other code modifications, examples of modifications to related code where modifications described in or similar to the natural language task 406 are performed. Continuing with this example, where the natural language task 406 describes refactoring, comments on pull requests may be used to identify pull requests where code is refactored. As a further example, documentation describing the modification described in a natural language task 406 may be accessed to identify examples of the modification described in the natural language task 406 and/or information describing how such a modification should be performed.

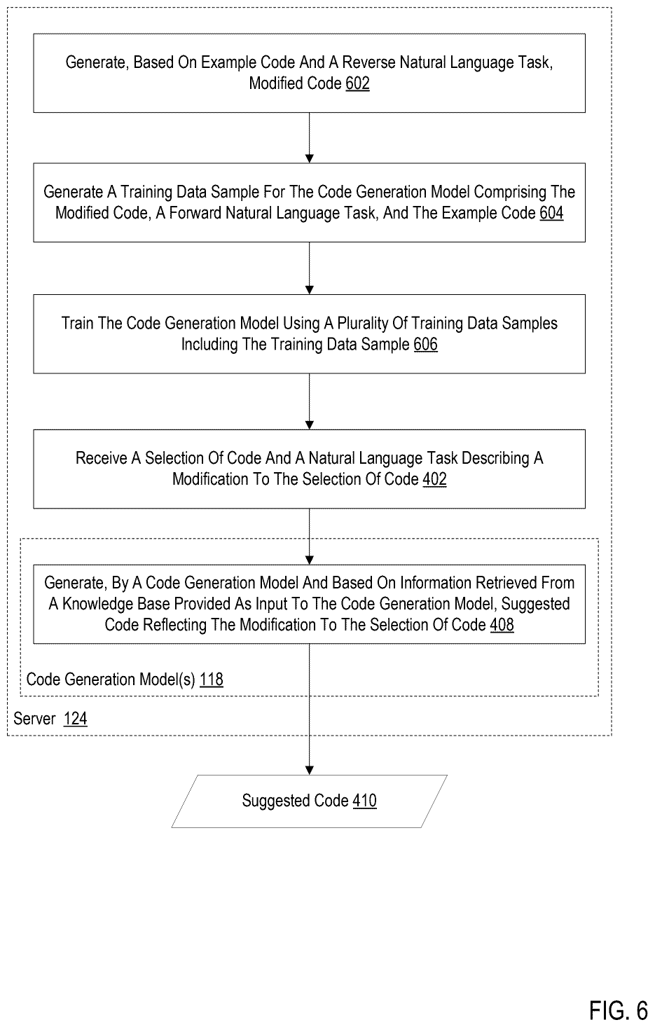

For further explanation, FIG. 6 sets forth a flowchart of another example method of using natural language to perform context-aware code generation in accordance with some embodiments of the present disclosure. The example method depicted in FIG. 6 is similar to the example method depicted in FIG. 4 as the example method depicted in FIG. 6 includes some of the same steps. The method of FIG. 6 describes approaches for training code generation model(s) 118 to perform modifications described in natural language tasks 406.

The method of FIG. 6 also includes generating 602, based on example code and a reverse natural language task, modified code. A reverse natural language task is a natural language description of some code modification that is the inverse or reverse of another natural language task, hereinafter referred to as a “forward natural language task.” In other words, given some sample code, applying the forward natural language task and the reverse natural language task (e.g., applying the modifications described therein) should result in the original sample code or code substantially similar to the original sample code. In some embodiments, the example code may include manually entered or created code. In some embodiments, the example code may include automatically generated code.

Generating 602 the modified code may include generating the modified code to reflect the modification described in the reverse natural language task. Put differently, generating 602 the modified code may include applying the modification described in the reverse natural language task to the example code to generate the modified code. In some embodiments, generating 602 the modified code may be performed by one or more trained models, such as one or more code generation model(s) 118. In some embodiments, the one or more code generation model(s) 118 may include a different code generation model 118 than will ultimately be trained as described below.

The method of FIG. 6 also includes generating 604 a training data sample for the code generation model 118 comprising the modified code, a forward natural language task, and the example code. Here, the forward natural language task corresponds to the reverse natural language task used to generate the modified code in that the reverse natural language task describes a reversal of the forward natural language task. In other words, applying the modification described in the forward natural language task to the modified code should result in the example code. Accordingly, the generated 604 training data sample for the code generation model 118 serves as an example of applying the forward natural language task to the modified code in order to generate the example code. In some embodiments, generating 604 the training data sample may include generating data that associates the modified code, the forward natural language task, and the example code. For example, generating 604 the training data sample may include creating an entry in a table or other data structure that includes the modified code, the forward natural language task, and the example code (e.g., as fields or other data points of the entry).

As an example, assume that a training data sample for adding comments to code is to be created. In other words, the training data sample serves as an example for a natural language task 406 describing adding comments to code (e.g., “Add comments to this code”). In this example, assume a portion of example code (e.g., automatically generated or manually created) that includes some amount of functional code and a corresponding comment. Modified code may be generated (e.g., using a trained model) from the example code using a reverse natural language task of “Remove comments from this code.” Accordingly, the modified code may include the functional code from the original example code without the comments. A training data sample may then be created including the modified code, a forward natural language task of “Add comments to this code,” and the example code. Thus, the training data sample serves as an example of adding comments to the uncommented modified code in order to generate the example code with comments.

As another example, assume that a training data sample for refactoring a function is to be created. In other words, the training data sample serves as an example for a natural language task 406 describing refactoring code (e.g., “Refactor this code”). In this example, assume a portion of example code that includes multiple, relatively short, interrelated functions (e.g., that may call one another). Modified code may be generated from the example code using a reverse natural language task of “Combine these into a single function.” Accordingly, the modified code may include a single function that is functionally equivalent to the multiple functions in the example code. A training data sample may then be created including the modified code, a forward natural language task of “Refactor this code,” and the example code. Thus, the training data serves as an example of refactoring the single comment of the modified code in order to generate the multiple functions of the example code.

Readers will appreciate that, although the method of FIG. 6 describes generating a single training data sample, the approaches described therein may be repeatedly performed to generate a corpus of training data. Moreover, the particular forward and reverse natural language tasks may vary such that the corpus of training data may include examples of various different natural language tasks. Furthermore, readers will appreciate that the approaches for generating training data samples described above may be at least partially automated.

The method of FIG. 6 also includes training 606 the code generation model 118 using a plurality of training data samples including the training data sample. For example, in some embodiments, the code generation model 118 may include an instance of an already trained model. In such embodiments, the code generation model 118 may be further trained using the plurality of training data samples, effectively expanding the knowledge and capabilities of the code generation model 118 using the plurality of training data samples. This is in contrast to fully retraining the code generation model 118 using a corpus of training data serving as the full basis of the knowledge and capabilities of the code generation model 118.

The approaches set forth above provide for generation of a training data sample set for applying various natural language tasks using partially synthetic training data. Particularly, examples for performing a particular natural language task may be generated from example code reflecting the natural language task and a trained model configured to generate modified code reflecting the reversal of the natural language task as applied to the example code.

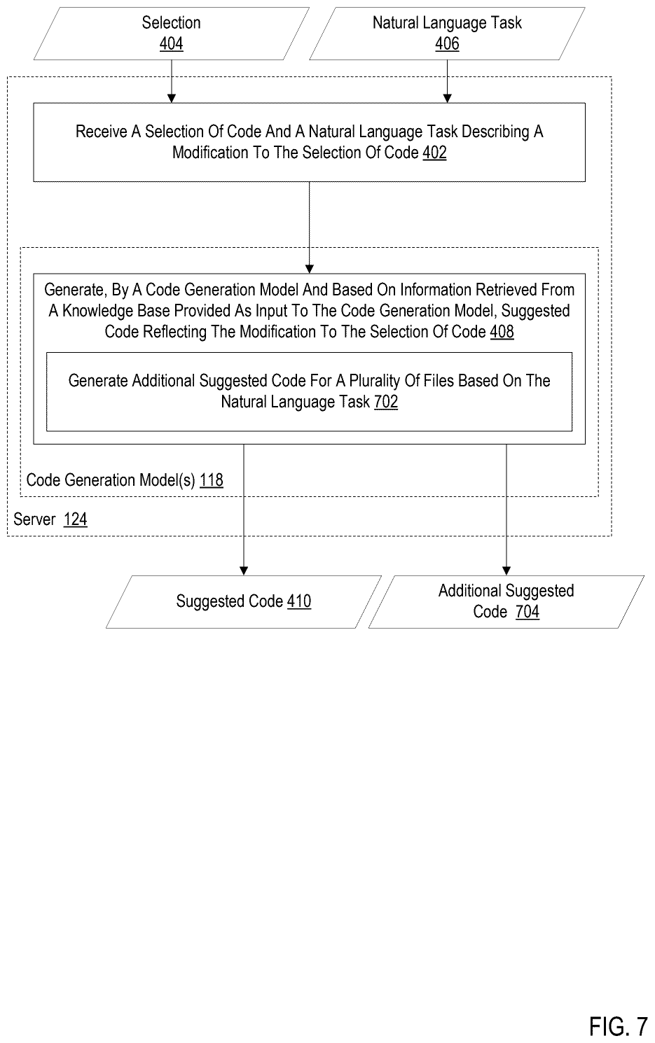

For further explanation, FIG. 7 sets forth a flowchart of another example method of using natural language to perform context-aware code generation in accordance with some embodiments of the present disclosure. The example method depicted in FIG. 7 is similar to the example method depicted in FIG. 4 as the example method depicted in FIG. 7 includes some of the same steps.

The method of FIG. 7 differs from FIG. 4 in that generating 408, by a code generation model 118 and based on information retrieved from a knowledge based provided as input to the code generation model 118, suggested code 410 reflecting the modification to the selection 404 of code also includes generating 702 additional suggested code for a plurality of files based on the natural language task 406. In other words, additional suggested code 704 is generated by the code generation model 118 based on code stored across multiple files. Thus, the additional suggested code 704 is generated based on the code stored in these multiple files so as to reflect the modification described in the natural language task 406. The additional suggested code 704 may be generated for the code in these multiple files by the code generation model(s) 118 according to similar approaches as are set forth above with respect to generating 408 the suggested code 410 for the selection 404 of code.

In some embodiments, generating 702 the additional suggested code may include identifying, in the plurality of files, one or more portions of code from which the additional suggested code 704 should be generated. In some embodiments, the one or more portions of code may be identified as being related to the selection 404 of code due to some interoperability with the selection 404 of code. For example, the one or more portions of code may be identified as functions or other portions of code calling the selection 404 of code or being called by the selection 404 of code. Continuing with this example, where the selection 404 of code includes some portion of front-end code, the one or more portions of code may be identified as portions of back-end code called by the selection 404 of code.

As another example, the one or more portions of code may be identified by detecting one or more compatibility or compilation issues resulting from replacing the selection 404 of code with the suggested code 410. Continuing with this example, assume that the selection 404 of code is a portion of a file written in a first programming language version. Further assume that the natural language task 406 is to migrate the selection 404 of code to a second version of the programming language. Were only the selection 404 of code migrated, this may introduce compatibility or compilation issues with the remaining code in the file and with other files of code in the same program. Accordingly, the remainder of the file and other related files in the program may be selected for migration, with their migrated code being reflected in the additional suggested code 704.

In some embodiments, in response to identifying one or more portions of code in other files for which additional suggested code 704 should be generated, a notification or message may be presented to a user (e.g., via the IDE 112) indicating that applying the natural language task 406 to the selection 404 of code may necessitate modification to other portions of code. Such a notification may be presented prior to or after generating 408 the suggested code 410. For example, such a notification may be presented with the suggested code 410 in the IDE 112. Such a notification may request confirmation as to whether additional suggested code 704 should be automatically generated 702 for the other portions of code, or may indicate that, should a user accept the suggested code 410 to replace the selection 404 of code, the additional suggested code 704 will be automatically generated and/or applied.

The approaches set forth above allow for generation of selected code across multiple files, particularly where generation of suggested code for some selection of code will affect operability with other portions of code. Thus, code stability may be maintained when replacing selections of code with suggested code.

Although some embodiments are described largely in the context of a generative AI system, a server with generative AI capabilities, or in some other way, readers of skill in the art will recognize that embodiments of the present disclosure may also take the form of a computer program product disposed upon computer readable storage media for use with any suitable processing system. Such computer readable storage media may be any storage medium for machine-readable information, including magnetic media, optical media, solid-state media, or other suitable media. Examples of such media include magnetic disks in hard drives or diskettes, compact disks for optical drives, magnetic tape, and others as will occur to those of skill in the art. Persons skilled in the art will immediately recognize that any computer system having suitable programming means will be capable of executing the steps described herein as embodied in a computer program product. Persons skilled in the art will recognize also that, although some of the embodiments described in this specification are oriented to software installed and executing on computer hardware, nevertheless, alternative embodiments implemented as firmware or as hardware are well within the scope of the present disclosure.

Readers will appreciate that some embodiments are described in which computer program instructions are executed on computer hardware such as, for example, one or more computer processors. Readers will appreciate that in other embodiments, computer program instructions may be executed on virtualized computer hardware (e.g., one or more virtual machines), in one or more containers, in one or more cloud computing instances (e.g., one or more AWS EC2 instances), in one or more serverless compute instances offered such as those offered by a cloud services provider, in one or more event-driven compute services such as those offered by a cloud services provider, or in some other execution environment.

In some examples, a non-transitory computer-readable medium storing computer-readable instructions may be provided in accordance with the principles described herein. The instructions, when executed by a processor of a computing device, may direct the processor and/or computing device to perform one or more operations, including one or more of the operations described herein. Such instructions may be stored and/or transmitted using any of a variety of known computer-readable media.

A non-transitory computer-readable medium as referred to herein may include any non-transitory storage medium that participates in providing data (e.g., instructions) that may be read and/or executed by a computing device (e.g., by a processor of a computing device). For example, a non-transitory computer-readable medium may include, but is not limited to, any combination of non-volatile storage media and/or volatile storage media. Exemplary non-volatile storage media include, but are not limited to, read-only memory, flash memory, a solid-state drive, a magnetic storage device (e.g., a hard disk, a floppy disk, magnetic tape, etc.), ferroelectric random-access memory (“RAM”), and an optical disc (e.g., a compact disc, a digital video disc, a Blu-ray disc, etc.). Exemplary volatile storage media include, but are not limited to, RAM (e.g., dynamic RAM).

One or more embodiments may be described herein with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof.

While particular combinations of various functions and features of the one or more embodiments are expressly described herein, other combinations of these features and functions are likewise possible. The present disclosure is not limited by the particular examples disclosed herein and expressly incorporates these other combinations.

What is claimed is:

1. A method comprising:
receiving a selection of code and a natural language task describing a modification to the selection of code; and
generating, by a code generation model and based on information retrieved from a knowledge base provided as input to the code generation model, suggested code reflecting the modification to the selection of code.

2. The method of claim 1 further comprising retrieving the information from the knowledge base based on a query comprising the natural language task.

3. The method of claim 1 wherein the selection of code and the natural language task are received from an integrated development environment (IDE) accessing code including the selection of code.

4. The method of claim 1 further comprising:
generating, based on example code and a reverse natural language task, modified code; and
generating a training data sample for the code generation model comprising the modified code, a forward natural language task, and the example code, wherein the forward natural language task comprises a particular code modification and the reverse natural language task comprises a reversal of the particular code modification.

5. The method of claim 4 wherein the training data sample facilitates training the code generation model to perform the particular code modification.

6. The method of claim 4 further comprising training the code generation model using a plurality of training data samples including the training data sample.

7. The method of claim 4 wherein generating the modified code is performed at least in part by another trained model.

8. The method of claim 1 wherein generating the suggested code comprises generating additional suggested code for a plurality of files based on the natural language task.

9. A non-transitory computer readable storage medium storing instructions which, when executed, cause a processing device to:
receive a selection of code and a natural language task describing a modification to the selection of code; and
generate, by a code generation model and based on information retrieved from a knowledge base provided as input to the code generation model, suggested code reflecting the modification to the selection of code.

10. The non-transitory computer readable storage medium storing of claim 9 wherein the instructions, when executed, further cause the processing device to retrieve the information from the knowledge base based on a query comprising the natural language task.

11. The non-transitory computer readable storage medium storing of claim 9 wherein the selection of code and the natural language task are received from an integrated development environment (IDE) accessing code including the selection of code.

12. The non-transitory computer readable storage medium storing of claim 9 wherein the instructions, when executed, further cause the processing device to:
generate, based on example code and a reverse natural language task, modified code; and
generate a training data sample for the code generation model comprising the modified code, a forward natural language task, and the example code, wherein the forward natural language task comprises a particular code modification and the reverse natural language task comprises a reversal of the particular code modification.

13. The non-transitory computer readable storage medium storing of claim 12 wherein the training data sample facilitates training the code generation model to perform the particular code modification.

14. The non-transitory computer readable storage medium storing of claim 12 wherein the instructions, when executed, further cause the processing device to train the code generation model using a plurality of training data samples including the training data sample.

15. The non-transitory computer readable storage medium storing of claim 12 wherein generating the modified code is performed at least in part by another trained model.

16. The non-transitory computer readable storage medium storing of claim 9 wherein, to generate the suggested code, the instructions, when executed, cause the processing device to generate additional suggested code for a plurality of files based on the natural language task.

17. A system comprising:
a memory;
a processing device, operatively coupled to the memory, the processing device configured to:
receive a selection of code and a natural language task describing a modification to the selection of code; and
generate, by a code generation model and based on information retrieved from a knowledge base provided as input to the code generation model, suggested code reflecting the modification to the selection of code.

18. The system of claim 17 wherein the processing device is further configured to retrieve the information from the knowledge base based on a query comprising the natural language task.

19. The system of claim 17 wherein the selection of code and the natural language task are received from an integrated development environment (IDE) accessing code including the selection of code.

20. The system of claim 17 wherein the processing device is further configured to:
generate, based on example code and a reverse natural language task, modified code; and
generate a training data sample for the code generation model comprising the modified code, a forward natural language task, and the example code, wherein the forward natural language task comprises a particular code modification and the reverse natural language task comprises a reversal of the particular code modification.
